(19) United States
(12) Patent Application Publication
(10) Pub. No.: US 2014/0310248 A1
(43) Pub. Date: Oct. 16, 2014

(54) VERIFICATION SUPPORT PROGRAM, VERIFICATION SUPPORT APPARATUS, AND VERIFICATION SUPPORT METHOD

(71) Applicant: FUJITSU LIMITED, Kawasaki-shi (JP)

(72) Inventor: Shun GOKITA, Kawasaki (JP)

(73) Assignee: FUJITSU LIMITED, Kawasaki-shi (JP)

(21) Appl. No.: 14/189,075

(22) Filed: Feb. 25, 2014

(30) Foreign Application Priority Data
Apr. 10, 2013 (JP) 2013-082534

(51) Int. Cl. G06F 17/30

(52) U.S. Cl. CPC G06F 17/30371
USPC 707/687

(57) ABSTRACT

A verification support method includes: referring to a storage to select a second use case to be verified next to a first use case selected from a use case group from the use case group on the basis of a postcondition of the first use case and a precondition of a use case different from the first use case, the storage storing, for use case representing a function of a verification target, the precondition that is met by an input value to be input into the verification target and an output value to be output from the verification target before the function represented by the use case is executed and the postcondition that is met by the input value and the output value after the function represented by the use case is executed.

### CROSS-REFERENCE TO RELATED APPLICATION

This application is based upon and claims the benefit of priority of the prior Japanese Patent Application No. 2013-082534, filed on Apr. 10, 2013, the entire contents of which are incorporated herein by reference.

### FIELD

The embodiments discussed herein are related to a program product storing a verification support program, a storage medium storing the verification support program, a verification support apparatus, and a verification support method.

### BACKGROUND

Use cases represent the functions of hardware or software. Technologies are provided to verify the hardware or the software by using the use cases. Technologies in related art include, for example, a technology to determine whether a descriptive set composed of use cases associated with related information indicating the relationship between the use cases extracted from a use case diagram forms a directed cycle to set the priority of each use case on the basis of the result of the determination and a technology to associate one set of transition from the initial state matched with the context of a certain use case to one final state corresponding to a system response from the use case with the use case.

Japanese Laid-open Patent Publication No. 2006-252489 and Japanese National Publication of International Patent Application No. 2007-528069 are examples of related art, for example.

However, with the technologies in the related art, since the state of a verification target, such as the hardware or the software, is varied each time the use case representing the function of the verification target is executed, the state of the verification target is varied in accordance with a use case to be verified next and, thus, it takes a long time to perform the verification.

### SUMMARY

According to an aspect of the invention, a verification support method includes: referring to a storage to select a second use case to be verified next to a first use case selected from a use case group from the use case group on the basis of a postcondition of the first use case and a precondition of a use case different from the first use case, the storage storing, for use case representing a function of a verification target, the precondition that is met by an input value to be input into the verification target and an output value to be output from the verification target before the function represented by the use case is executed and the postcondition that is met by the input value and the output value after the function represented by the use case is executed.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a descriptive diagram illustrating an exemplary operation of a verification support apparatus according to an embodiment;

FIG. 2 is a block diagram illustrating an exemplary hardware configuration of the verification support apparatus;

FIG. 3 is a descriptive diagram illustrating an exemplary use case diagram;

FIG. 4 is a descriptive diagram illustrating an example of how a single-function use case is used;

FIG. 5 is a block diagram illustrating exemplary functions of the verification support apparatus;

FIG. 6 is a descriptive diagram illustrating an example of how to extract a precondition and a postcondition;

FIG. 7 is a descriptive diagram illustrating a first stage in an example of determination of the verification order of use cases;

FIG. 8 is a descriptive diagram illustrating a second stage in the example of the determination of the verification order of the use cases;

FIG. 9 is a descriptive diagram illustrating a third stage in the example of the determination of the verification order of the use cases;

FIG. 10 is a descriptive diagram illustrating a fourth stage in the example of the determination of the verification order of the use cases;

FIG. 11A and FIG. 11B are descriptive diagrams illustrating another example of the determination of the verification order of the use cases;

FIG. 12 is a flowchart illustrating an exemplary process of generating a test pattern;

FIG. 13 is a flowchart illustrating an exemplary process of extracting the precondition and the postcondition;

FIG. 14 is a first flowchart illustrating an example of a process of determining the verification order of the use cases;

FIG. 15 is a second flowchart illustrating the example of the process of determining the verification order of the use cases;

FIG. 16 is a flowchart illustrating an exemplary process of grouping the use cases;

FIG. 17 is a first flowchart illustrating another example of the process of determining the verification order of the use cases; and

FIG. 18 is a second flowchart illustrating the other example of the process of determining the verification order of the use cases.

### DESCRIPTION OF EMBODIMENTS

A verification support program, a verification support apparatus, and a verification support method according to embodiments will herein be described in detail with reference to the attached drawings.

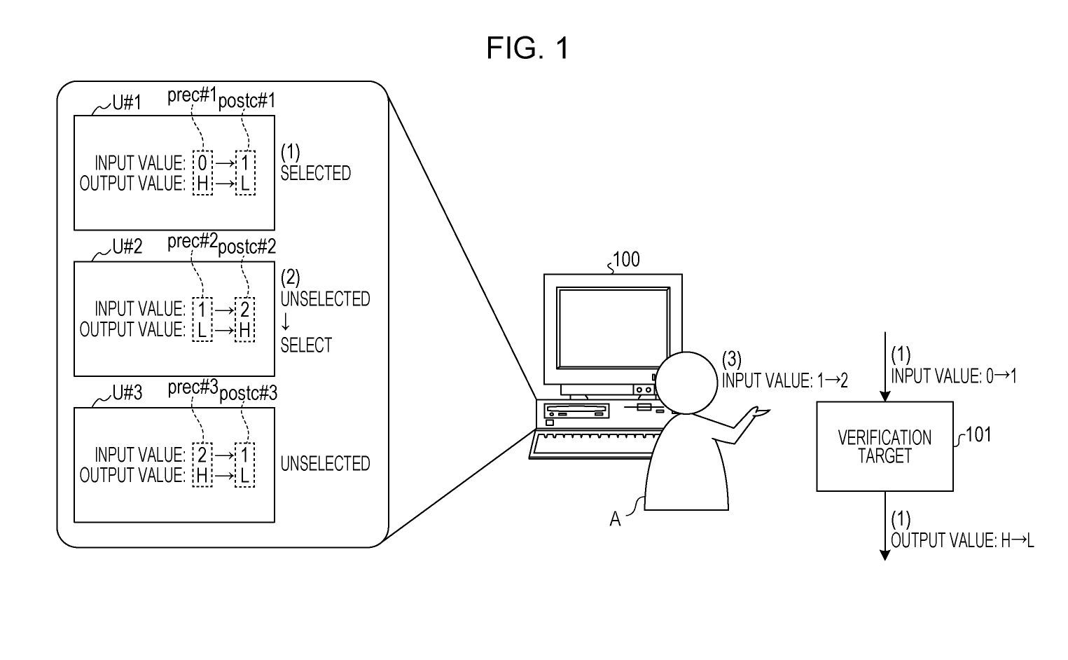

FIG. 1 is a descriptive diagram illustrating an exemplary operation of a verification support apparatus according to an embodiment. Referring to FIG. 1, a verification support apparatus 100 is a computer that assists a verification operation by a verifier. How to verify a verification target by the verifier will be described here.

Since software, hardware, and systems including software and hardware, which are to be verified, are increased in size from day to day, the ratio of the verification to the entire development of the verification target tends to be increased. In the verification of the verification target by the verifier, the verifier performs the verification in accordance with a test pattern. The test pattern is information in which the verification order of verification items is described. The verification items are used to verify whether the function of the verification target meets predetermined specifications.

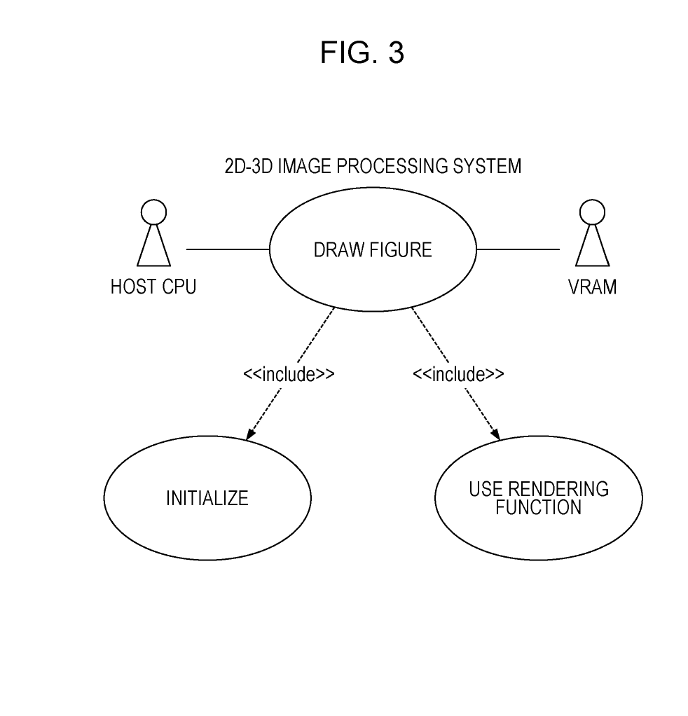

It takes longer time to manually generate the test pattern with the increasing size of the system to be verified. Accordingly, technologies to assist the generation of the test pattern include, for example, a technology to extract the verification items concerning the use case representing the function of the verification target from a use case diagram, which is one of the specifications. The use case is one of the concepts in Unified Modeling Language (UML) and is used to identify a requisite for the verification target. The use case will be described below with reference to FIG. 3.

However, the verification target may have a function to execute the function of a certain use case only if the verification target meets a certain condition. When the function of the certain use case is verified in accordance with the test pattern in this case, the verifier performs the verification after setting the state of the verification target so as to meet the certain condition of the verification target to increase the time and effort for the verification. In the generation of the test pattern from the verification items concerning the use case that is extracted by the verifier, omission of the verification items or variation in the verification items with the verifier may occur.

Accordingly, the verification support apparatus 100 according to the embodiment performs matching in a precondition and a postcondition between the use cases representing the functions of the verification target to select the use case that is continuously executed. Since the verification support apparatus 100 varies the state of the verification target in accordance with the use case to be verified next, the time and effort for the verification is reduced to increase the efficiency of the verification. It is assumed in the embodiments that the use case represents a function in which one input into the verification target provides one output.

The verification support apparatus 100 illustrated in FIG. 1 stores a precondition prec and a postcondition postc of each use case U representing a function of a verification target 101. The precondition prec of a use case is a condition that is met by an input value to be input into the verification target 101 and an output value to be output from the verification target 101 before the function represented by the use case is executed. The postcondition postc of a use case is a condition that is met by the input value and the output value after the function represented by the use case is executed.

In the example in FIG. 1, the verification support apparatus 100 stores a precondition prec#1 to a precondition prec#3 and a postcondition postc#1 to a postcondition postc#3 of a use case U#1 to a use case U#3, respectively. An input source that inputs the input value into the verification target 101 and an output destination that accepts the value output from the verification target 101 will be described below with reference to FIG. 3.

For example, the precondition prec#1 includes an input value “0” to be input into the verification target 101 before the function represented by the use case U#1 is executed and an output value “H” to be output from the verification target 101 before the function represented by the use case U#1 is executed. The postcondition postc#1 includes an input value “1” after the function represented by the use case U#1 is executed and an output value “L” after the function represented by the use case U#1 is executed.

It is assumed here that the verification support apparatus 100 illustrated in FIG. 1 selects the use case U#1 from the use case group including the use cases U#1 to U#3 as a first use case and a verifier A has verified the function represented by the use case U#1, as illustrated by (1). Then, the verification support apparatus 100 selects a second use case to be verified next to the use case U#1 from the use case group on the basis of the postcondition postc#1 and the precondition prec of a use case different from the use case U#1, as illustrated by (2).

For example, the verification support apparatus 100 selects the use case having the precondition prec coinciding with the postcondition postc#1 as the second use case. In the example in FIG. 1, the verification support apparatus 100 selects the use case U#2 having the precondition prec#2 coinciding with a first condition: the input value “1” and a second condition: the output value “L” in the postcondition postc#1 as the second use case.

For example, the verification support apparatus 100 may select the use case having the precondition prec having the maximum rate of coincidence with the postcondition postc#1 as the second use case. If the use case U#2 is not included in the use case group and a use case having the precondition prec meeting either of the two conditions in the postcondition postc#1 exists in the example in FIG. 1, the verification support apparatus 100 selects this use case as the second use case.

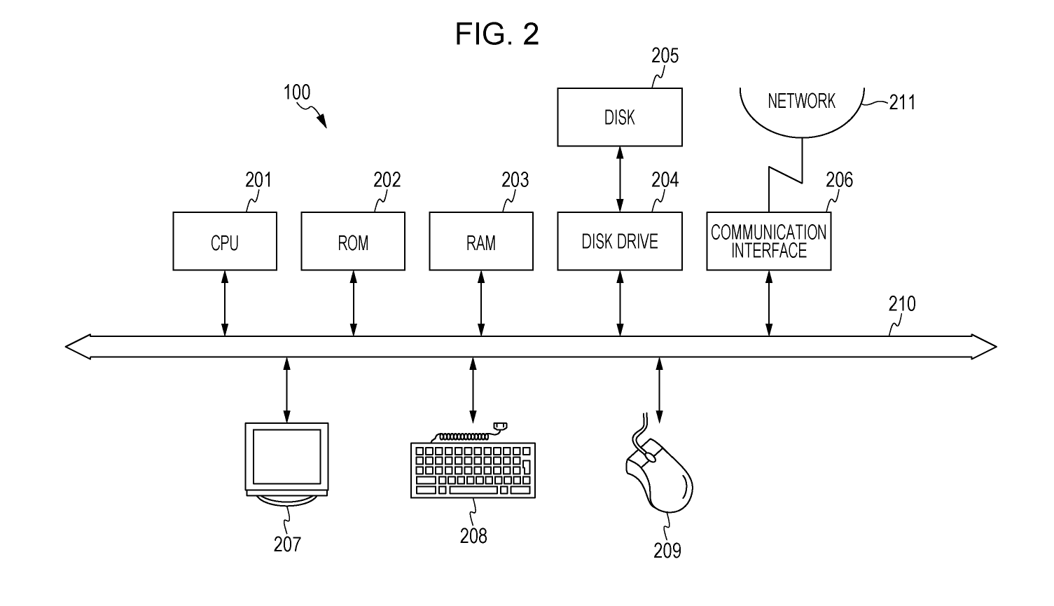

Then, the verification support apparatus 100 outputs the selected second use case. The verifier A who has browsed the output result operates the input source so that the input value is varied from “1” to “2” to verify the function represented by the second use case, as illustrated by (3). The verification support apparatus 100 will be described with reference to FIG. 2 to FIG. 18.

Hardware of Verification Support Apparatus 100

FIG. 2 is a block diagram illustrating an exemplary hardware configuration of the verification support apparatus. Referring to FIG. 2, the verification support apparatus 100 includes a central processing unit (CPU) 201, a read only memory (ROM) 202, and a random access memory (RAM) 203. The verification support apparatus 100 also includes a disk drive 204, a disk 205, and a communication interface 206. The verification support apparatus 100 further includes a display 207, a keyboard 208, and a mouse 209. The components from the CPU 201 to the mouse 209 are connected to each other via a bus 210.

The CPU 201 is an arithmetic processing unit that controls the entire verification support apparatus 100. The ROM 202 is a non-volatile memory that stores programs including a boot program. The RAM 203 is a volatile memory used as a working area of the CPU 201.

The disk drive 204 is a control unit that controls reading of data from the disk 205 and writing of data to the disk 205 under the control of the CPU 201. For example, a magnetic disk drive, an optical disk drive, or a solid state drive may be adopted as the disk drive 204. The disk 205 is a non-volatile memory that stores data that is written under the control of the disk drive 204. For example, when the disk drive 204 is a magnetic disk drive, a magnetic disk may be adopted as the disk 205. When the disk drive 204 is an optical disk drive, an optical disk may be adopted as the disk 205. When the disk drive 204 is a solid state drive, a semiconductor device memory may be adopted as the disk 205.

The communication interface 206 is a control unit that functions as an internal interface with a network 211 and controls input of data from an external apparatus and output of data to an external apparatus. Specifically, the communication interface 206 is connected to, for example, a local area network (LAN), a wide area network (WAN), or the Internet, which is the network 211, via a communication line and is connected to another apparatus via the network 211. For example, a modem or a LAN adapter may be adopted as the communication interface 206.

The display 207 is a unit that displays a mouse cursor, icons, a tool box, document data, image data, and/or functional information. For example, a cathode ray tube (CRT), a thin film transistor (TFT) liquid crystal display, or a plasma display may be adopted as the display 207.

The keyboard 208 is a unit that includes keys used to input characters, numerals, various instructions, and so on and that is used to input data. The keyboard 208 may be a touch-panel input pad or a numerical keypad. The mouse 209 is a unit used to, for example, move the mouse cursor, select a range with the mouse cursor, move a window, or change the size of the window. The mouse 209 may be a trackball or a joystick as long as the trackball or the joystick has the same function as that of a pointing device.

FIG. 3 is a descriptive diagram illustrating an example of the use case diagram. The use case diagram is used to identify a functional request from a system, which is the verification target 101. Which actors exist in the verification target 101 and how each actor operates are described in the use case diagram. The operation performed by the actor is the use case.

The actor is an external apparatus or a person using the verification target 101. The use case is a service that is provided to the actor. The use case diagram may include multiple use cases and, in this case, related use cases may be connected to each other.

In the embodiments, the actor acting as the input source that inputs any value in the verification target 101 is referred to as an “input actor”. Similarly, the actor acting as the output destination that accepts any value output from the verification target 101 is referred to as an “output actor”.

For example, the use case diagram of a 2D-3D image processing system is illustrated in the example in FIG. 3. The 2D-3D image processing system provides a service “Draw figure” to a host CPU acting as the input actor. The 2D-3D image processing system outputs the result of drawing to a video RAM (VRAM) acting as the output actor. The use case “Draw figure” includes a use case “Initialize” and a use case “Use rendering function”.

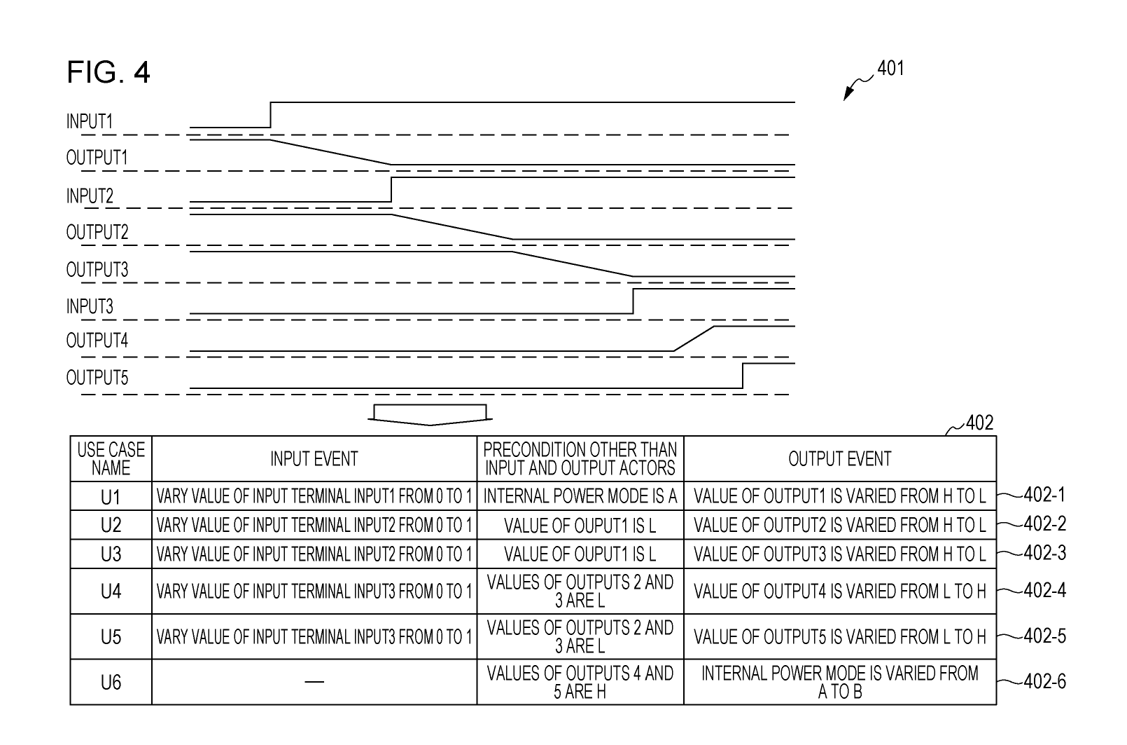

FIG. 4 is a descriptive diagram illustrating an example of how a single-function use case is used. In the example in FIG. 4, the single-function use case is extracted from a sequence operation. The single-function use case results from subdivision of the input and output actors in each use case into one input actor and one output actor. The use of the single-function use case enables representation in fine units, compared with the commonly-used use case.

A sequence of an input terminal INPUT1 to an input terminal INPUT3 and an output terminal OUTPUT1 to an output terminal OUTPUT5 is indicated in a sequence operation 401 in the example in FIG. 4. The single-function use cases are extracted from the sequence operation 401 to arrange the extracted single-function use cases in a single-function use case table 402.

The single-function use case table 402 includes four fields: a use case name, an input event, a precondition other than input and output actors, and an output event. The name of each use case is stored in the use case name field. The single-function use case table 402 includes records 402-1 to 402-6. Information indicating an input event in which the input actor inputs the input value is stored in the input event field. The precondition other than the input and output actors, which allows the use case to be executed, is stored in the precondition other than input and output actors field. Information indicating an output event in which the verification target 101 outputs the output value is stored in the output event field.

For example, in the record 402-1, the use case name is “U1”, the input event is “Vary value of input terminal INPUT1 from 0 to 1”, the precondition other than input and output actors is “Internal power mode is A”, and the output event is “Value of OUTPUT1 is varied from H to L”.

Functions of Verification Support Apparatus 100

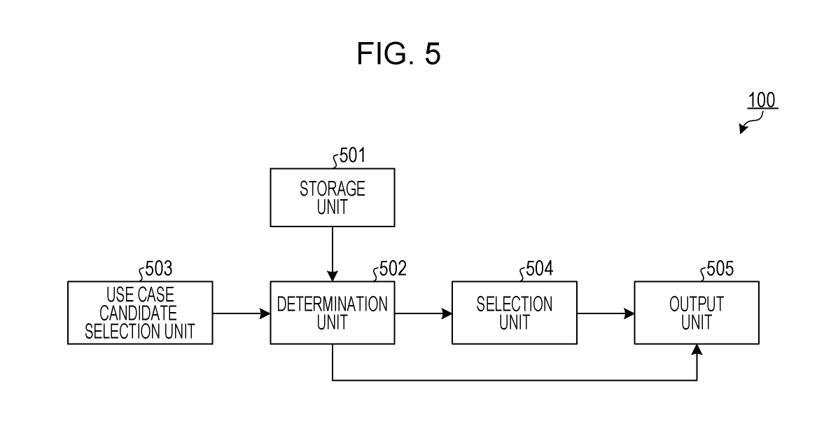

The functions of the verification support apparatus 100 will now be described. FIG. 5 is a block diagram illustrating exemplary functions of the verification support apparatus. Referring to FIG. 5, the verification support apparatus 100 includes a storage 501, a determination unit 502, a use case candidate selection unit 503, a selection unit 504, and an output unit 505. The functions of the determination unit 502 to the output unit 505, which are controllers, are realized by the CPU 201 that executes programs stored in a storage area. The storage area is, for example, the ROM 202, the RAM 203, or the disk 205 illustrated in FIG. 2. The functions of the determination unit 502 to the output unit 505 may be realized by another CPU that executes the programs via the communication interface 206.

The verification support apparatus 100 is capable of accessing the storage 501. The storage 501 is stored in the storage area, such as the RAM 203 or the disk 205.

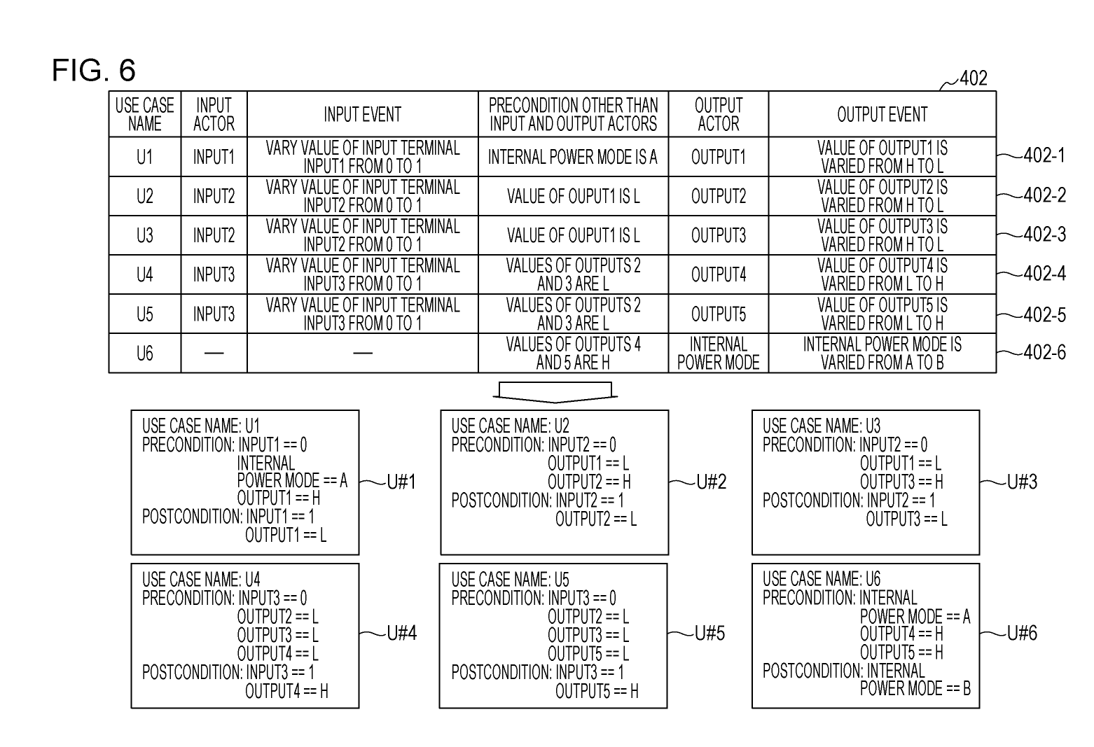

The storage 501 stores the precondition and the postcondition of each use case representing a function of the verification target 101. Specific examples of the precondition of the use case and the postcondition of the use case will be described below with reference to FIG. 6.

The determination unit 502 determines whether the use case having the precondition coinciding with the postcondition of the first use case exists in unselected use cases that are not selected from the use case group. The unselected use cases that are not selected are the use cases different from the use case selected by the selection unit 504 and the use case selected by the use case candidate selection unit 503 in the use case group.

The determination unit 502 may determine whether the use case having the precondition including the postcondition of the first use case exists in the unselected use cases that are not selected from the use case group. For example, it is assumed that the postcondition of the first use case includes the condition of one output value: the first output value OUTPUT1 has a value of L. It is also assumed that the precondition of a certain use case, among the unselected use cases, includes the conditions of two output values: the first output value OUTPUT1 has a value of “L” and the second output value OUTPUT2 has a value of “H”. In this case, since the precondition of the certain use case includes the postcondition of the first use case, the determination unit 502 determines that the use case having the precondition including the postcondition of the first use case exists.

The determination unit 502 may determine whether the use case having the precondition coinciding with the condition resulting from update of the initial state specified by a user with the postcondition of the first use case exists.

The determination unit 502 may determine whether the use case having the precondition coinciding with the postcondition of a use case candidate selected by the use case candidate selection unit 503 exists in the unselected use cases.

It is assumed that the determination unit 502 determines that no use case having the precondition coinciding with the postcondition of the first use case exists in the unselected use cases. In this case, the determination unit 502 may further determine whether a specific use case is included in the use cases selected from the use case group.

The specific use case is the use case that is specified by the verifier in the use case group and that is to be executed at the end of the verification, and is a target use case. The specific use case is hereinafter referred to as the “target use case”. For example, it is assumed that a use case “Terminate” exists, in addition to the use cases illustrated in FIG. 3, when the verification target 101 is the 2D-3D image processing system illustrated in FIG. 3. In this case, the verifier specifies the use case “Terminate” as the target use case.

If the determination unit 502 determines that multiple use cases having the precondition coinciding with the postcondition of the first use case exist in the unselected use cases, the determination unit 502 may determine whether the target use case is included in the multiple use cases. The result of the determination is stored in the storage area, such as the RAM 203 or the disk 205.

It is assumed that the determination unit 502 determines that multiple use cases having the precondition coinciding with the postcondition of the first use case exist in the unselected use cases. In this case, the use case candidate selection unit 503 selects the use case candidate to be verified next to the first use case from the multiple use cases. When the multiple use cases are the use case U#2 and the use case U#3, the use case candidate selection unit 503 selects, for example, the use case U#2 as the use case candidate.

It is assumed that the determination unit 502 determines that no use case having the precondition coinciding with the postcondition of the use case candidate selected by the use case candidate selection unit 503 exists in the unselected use cases. In this case, the use case candidate selection unit 503 may select the unselected use case that is not selected from the multiple use cases as the use case candidate.

For example, it is assumed that the multiple use cases are the use case U#2 and the use case U#3 and the use case candidate selection unit 503 selects the use case U#2 as the use case candidate and that the determination unit 502 determines that no use case having the precondition coinciding with the postcondition of the use case U#2 exists in the unselected use cases. In this case, the use case candidate selection unit 503 selects the use case U#3 as the use case candidate. The result of the selection is stored in the storage area, such as the RAM 203 or the disk 205.

The selection unit 504 refers to the storage 501 to select the second use case to be verified next to the first use case on the basis of the postcondition of the first use case selected from the use case group and the precondition of a use case different from the first use case. For example, the selection unit 504 may select the use case having the precondition prec having the maximum rate of coincidence with the postcondition of the first use case as the second use case.

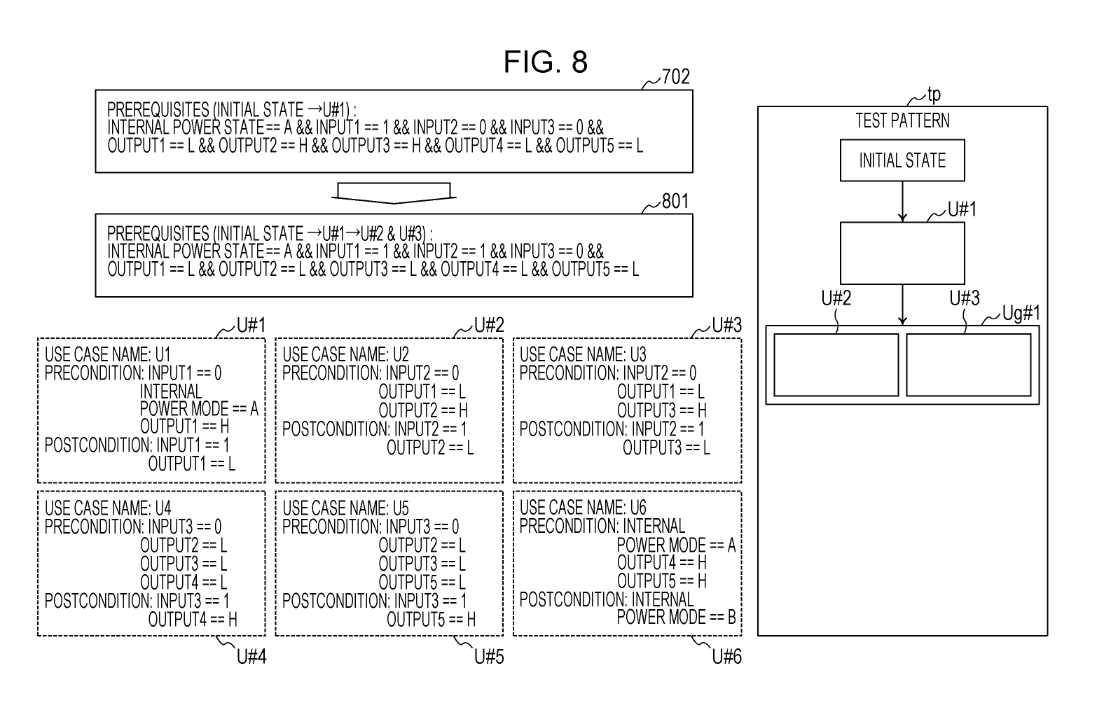

The selection unit 504 may select the second use case having the precondition coinciding with the postcondition of the first use case from the use case group. For example, when multiple use cases having the precondition coinciding with the postcondition of the first use case exist, the selection unit 504 selects any of the multiple use cases as the second use case. When multiple use cases having the precondition coinciding with the postcondition of the first use case exist and the multiple use cases simultaneously occur, the selection unit 504 may select all the multiple use cases as the second use case. An example of how to determine whether the use cases simultaneously occur will be described below with reference to FIG. 8.

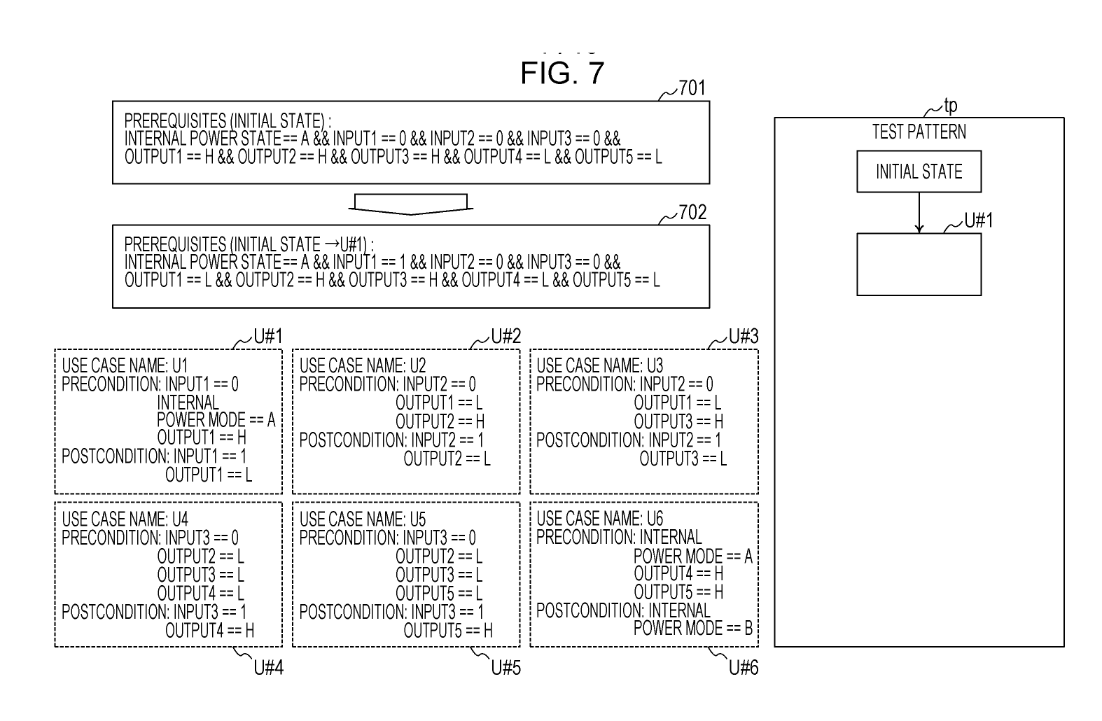

It is assumed that the determination unit 502 determines that the use case having the precondition coinciding with the postcondition of the first use case exists in the unselected use cases. In this case, the selection unit 504 may select the second use case having the precondition coinciding with the postcondition of the first use case. A specific example of how to select the second use case will be described below with reference to, for example, FIG. 7.

If the determination unit 502 determines that the use case having the precondition coinciding with the postcondition of the use case candidate exists in the unselected use cases, the selection unit 504 may select the use case candidate as the second use case.

If the determination unit 502 determines that the target use case is included in the multiple use cases, the selection unit 504 may select the target use case as the second use case.

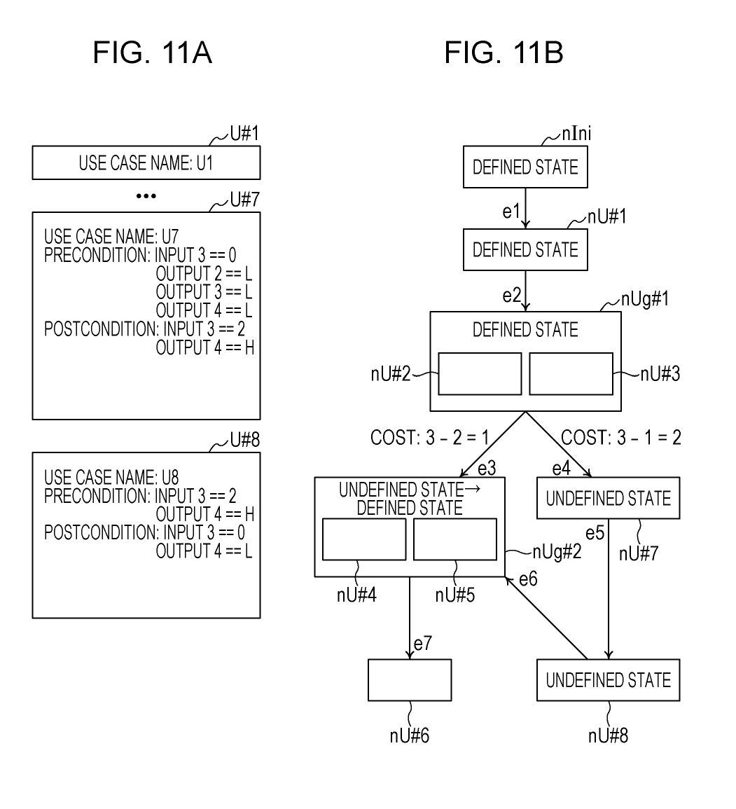

If the determination unit 502 determines that the target use case is not included in the multiple use cases, the selection unit 504 may select the second use case from the multiple use cases on the basis of the postcondition of each of the multiple use cases and the precondition of the target use case. An example of how to select the second use case on the basis of the postcondition of each of the multiple use cases and the precondition of the target use case will be described below with reference to FIG. 11A and FIG. 11B.

The selection unit 504 may select the use case that is to be first verified from the use case group on the basis of the initial values of the input value and the output value and the precondition of each of the use cases in the use case group. The initial values of the input value and the output value are specified by the verifier. Specifically, the selection unit 504 may select the use case all the conditions in the precondition of which are met by the initial values of the input value and the output value or may select the use case having the maximum number of conditions in the precondition of which are met by the initial values of the input value and the output value. The result of the selection is stored in the storage area, such as the RAM 203 or the disk 205.

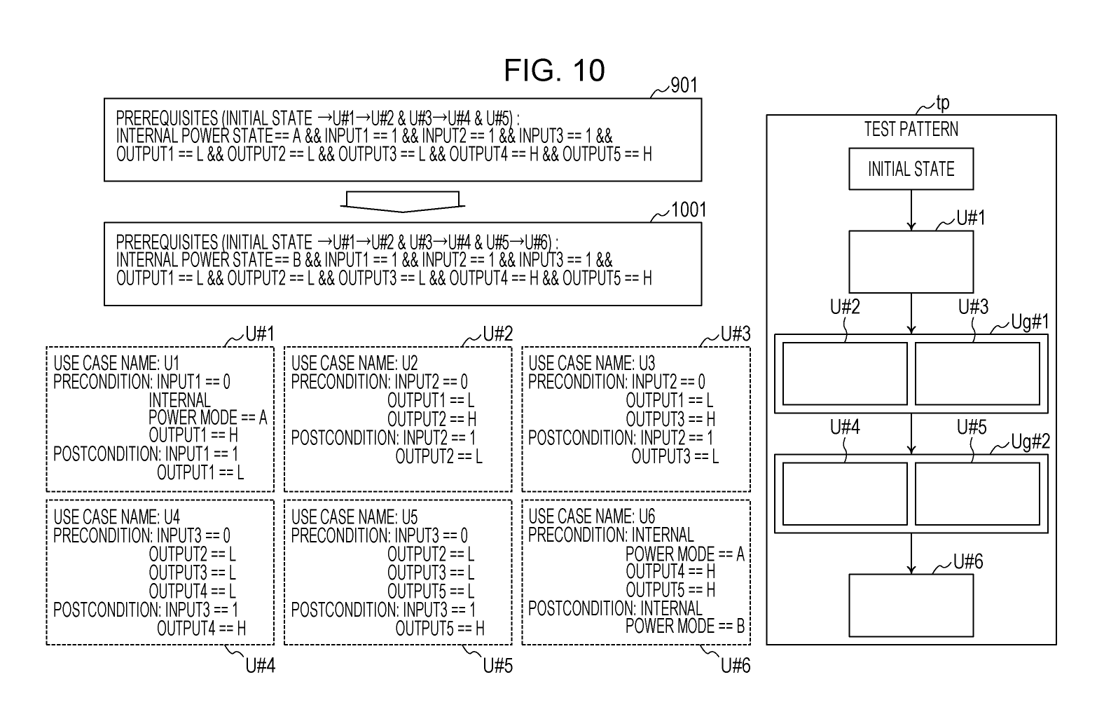

The output unit 505 outputs information indicating the selection order of the use cases selected from the use case group if the determination unit 502 determines that no use case having the precondition coinciding with the postcondition of the first use case exists. A specific example of how to output the information will be described below with reference to FIG. 10. The information indicating the selection order of the use cases selected from the use case group is the test pattern described above with reference to FIG. 1.

It is assumed that the determination unit 502 determines that no use case having the precondition coinciding with the postcondition of the first use case exists and that the target use case is not included in the use cases selected from the use case group. In this case, the output unit 505 may output information indicating that the specifications of the verification target 101 are incorrect. The information indicating that the specifications of the verification target 101 are incorrect may be a simple character string “Incorrect” or may be a character string “Does not reach target use case U#x” when the target use case is a use case U#x.

For example, the output unit 505 may display the output information in the display 207 or may transmit the output information to an external apparatus via the communication interface 206. The output unit 505 may store the output information in the storage area, such as the RAM 203 or the disk 205.

FIG. 6 is a descriptive diagram illustrating an example of how to extract the precondition and the postcondition. The verification support apparatus 100 extracts the precondition and the postcondition of the use case U from the single-function use case table 402. The verification support apparatus 100 extracts the precondition and the postcondition of the use case for every record in the single-function use case table 402. In the example in FIG. 6, the verification support apparatus 100 extracts the preconditions and the postconditions of the use case U#1 to the use case U#6 from the record 402-1 to the record 402-6, respectively.

Specifically, in the case of the precondition, the verification support apparatus 100 adds the input value of the input actor before the input event occurs to the precondition. The verification support apparatus 100 also adds the output value of the output actor before the output event occurs to the precondition. The verification support apparatus 100 further adds the precondition other than the input and output actors to the precondition.

In the case of the postcondition, the verification support apparatus 100 adds the input value of the input actor after the input event occurred to the postcondition. The verification support apparatus 100 also adds the output value of the output actor after the output event occurred to the postcondition.

The use case U#1 to the use case U#6 illustrated in FIG. 6 may include or may not include the input actor, the input event, the precondition other than input and output actors, the output actor, and the output event in the corresponding records. The input actor, the input event, the precondition other than input and output actors, the output actor, and the output event are information that is referred to in grouping of the use cases described below with reference to FIG. 8. Accordingly, the verification support apparatus 100 includes the input actor, the input event, the precondition other than input and output actors, the output actor, and the output event in the record of each use case in the grouping of the use cases.

Although the preconditions and the postconditions of the use cases illustrated in FIG. 6 are the conditions indicating whether the conditions coincide with certain values, the preconditions and the postconditions of the use cases may be conditions specifying value ranges, such as a condition that is lower than a certain value.

FIG. 7 to FIG. 10 illustrate examples of how to connect the use cases. The initial state is specified by the user in FIG. 7 to FIG. 10. It is assumed that the use case U#6 is specified as the target use case by the user.

FIG. 7 is a descriptive diagram illustrating a first stage in an example of determination of the verification order of the use cases. The verification support apparatus 100 sets the initial state specified by the user in prerequisites 701. The prerequisites 701 are “internal power state==A && INPUT1==0 && INPUT2==0 && INPUT3==0 && OUTPUT1==H && OUTPUT2==H && OUTPUT3==H && OUTPUT4==L && OUTPUT5=L”.

The verification support apparatus 100 detects the use case having the precondition meeting all the prerequisites 701 from the use case U#1 to the use case U#6. In the example in FIG. 7, the use case having the precondition meeting all the prerequisites 701 is the use case U#1. Since one use case is detected, the verification support apparatus 100 selects the use case U#1 as the use case to be executed next to the initial state in a test pattern tp.

After the use case is selected, the verification support apparatus 100 updates the prerequisites 701. Specifically, the verification support apparatus 100 updates the prerequisites 701 with the postcondition of the use case that is selected to create prerequisites 702. The prerequisites 702 result from update of the value of INPUT1 and the value of OUTPUT1 in the prerequisites 701. The values that are updated are hatched in FIG. 7 to FIG. 10.

The prerequisites 702 are “internal power state==A && INPUT1==1 && INPUT2==0 && INPUT3==0 && OUTPUT1=L && OUTPUT2==H && OUTPUT3==H && OUTPUT4==L && OUTPUT5=L”.

FIG. 8 is a descriptive diagram illustrating a second stage in the example of the determination of the verification order of the use cases. The verification support apparatus 100 detects the use cases having the precondition meeting all the prerequisites 702 from the use case U#2 to the use case U#6. In the example in FIG. 8, the use cases having the precondition meeting all the prerequisites 702 are the use case U#2 and the use case U#3.

When the multiple use cases having the precondition meeting all the prerequisites 702 exist, the verification support apparatus 100 determines whether the multiple use cases meet a condition that the multiple use cases have the same precondition other than the input and output actors and the same input event and have different output events. Since the multiple use cases simultaneously occur if the above condition is met, the verification support apparatus 100 groups the multiple use cases into one use case.

Since the use case U#2 and the use case U#3 have the same precondition other than the input and output actors and the same input event and have different output events, the use case U#2 and the use case U#3 may be grouped into one use case.

Since inconsistency is caused if the use cases that have the same precondition other than the input and output actors and the same input event, have a common output actor, and have different output events simultaneously occurs, the verification support apparatus 100 does not group such use cases.

The verification support apparatus 100 selects a use case Ug#1 resulting from grouping of the use case U#2 and the use case U#3 as the use case to be executed next to the use case U#1 in the test pattern tp. After the use case is selected, the verification support apparatus 100 updates the prerequisites 702. Specifically, the verification support apparatus 100 updates the prerequisites 702 with the postcondition of the use case that is selected to create prerequisites 801. The prerequisites 801 result from update of the value of INPUT2, the value of OUTPUT2, and the value of OUTPUT3 in the prerequisites 702.

The prerequisites 801 are “internal power state==A && INPUT1==1 && INPUT2==1 && INPUT3==0 && OUTPUT1=L && OUTPUT2==L && OUTPUT3==L && OUTPUT4==L && OUTPUT5=L”.

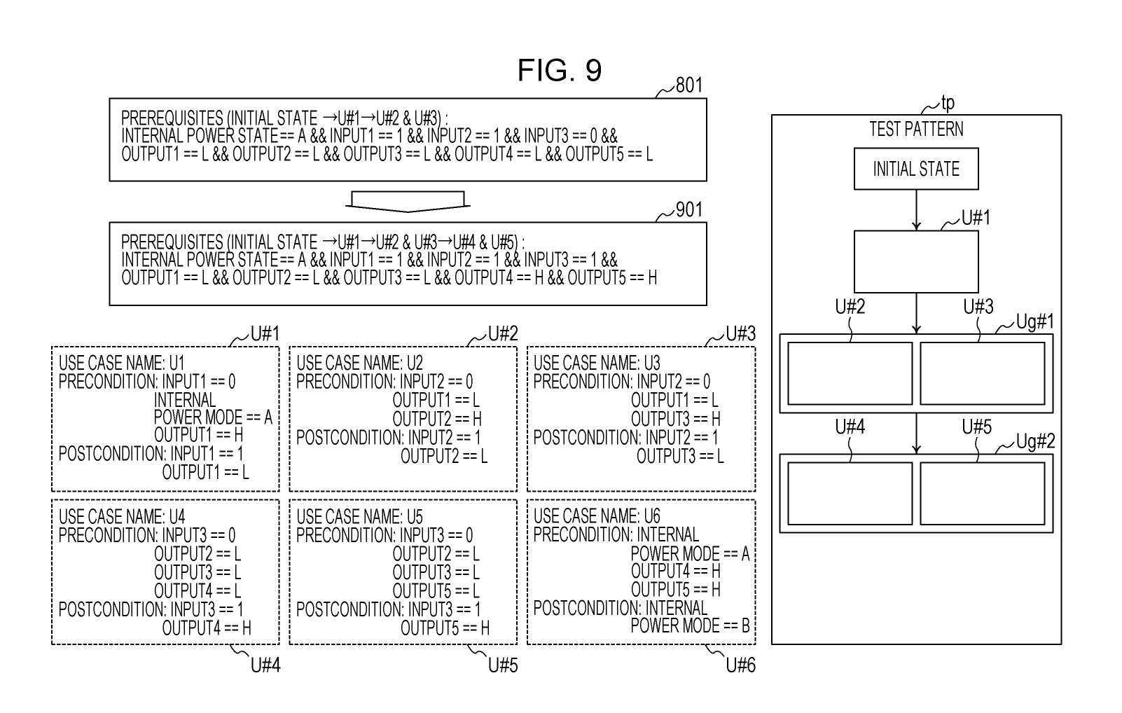

FIG. 9 is a descriptive diagram illustrating a third stage in the example of the determination of the verification order of the use cases. The verification support apparatus 100 detects the use cases having the precondition meeting all the prerequisites 801 from the use case U#4 to the use case U#6. In the example in FIG. 9, the use cases having the precondition meeting all the prerequisites 801 are the use case U#4 and the use case U#5. Since the use case U#4 and the use case U#5 have the same precondition other than the input and output actors and the same input event and have different output events, the use case U#4 and the use case U#5 may be grouped into one use case.

The verification support apparatus 100 selects a use case Ug#2 resulting from grouping of the use case U#4 and the use case U#5 as the use case to be executed next to the use case Ug#1 in the test pattern tp. After the use case is selected, the verification support apparatus 100 updates the prerequisites 801. Specifically, the verification support apparatus 100 updates the prerequisites 801 with the postcondition of the use case that is selected to create prerequisites 901. The prerequisites 901 result from update of the value of INPUT3, the value of OUTPUT4, and the value of OUTPUT5 in the prerequisites 801.

The prerequisites 901 are “internal power state==A && INPUT1==1 && INPUT2==1 && INPUT3==1 && OUTPUT1=L && OUTPUT2==L && OUTPUT3==L && OUTPUT4==H && OUTPUT5=H”.

FIG. 10 is a descriptive diagram illustrating a fourth stage in the example of the determination of the verification order of the use cases. The verification support apparatus 100 detects the use case having the precondition meeting all the prerequisites 901 from the use case U#6. In the example in FIG. 10, the use case meeting the prerequisites 901 is the use case U#6. The verification support apparatus 100 selects use case U#6 as the use case to be executed next to the use case Ug#2 in the test pattern tp.

After the use case is selected, the verification support apparatus 100 updates the prerequisites 901. Specifically, the verification support apparatus 100 updates the prerequisites 901 with the postcondition of the use case that is selected to create prerequisites 1001. The prerequisites 1001 result from update of the value of the internal power state in the prerequisites 901.

The prerequisites 1001 are “internal power state==B && INPUT1==1 && INPUT2==1 && INPUT3==1 && OUTPUT1=L && OUTPUT2==L && OUTPUT3==L && OUTPUT4==H && OUTPUT5=H”.

Since the use case U#6 is selected to reach the target use case, the verification support apparatus 100 outputs the test pattern. In the example in FIG. 10, the verification support apparatus 100 outputs “initial state→U#1→U#2 & U#3→U#4 & U#5→U#6”. The verification support apparatus 100 may output the change order of the input events along with the test pattern. For example, in the example in FIG. 10, the verification support apparatus 100 sequentially outputs character strings “Vary value of input terminal INPUT1 from 0 to 1”, “Vary value of input terminal INPUT2 from 0 to 1”, and “Vary value of input terminal INPUT3 from 0 to 1”.

Another example of the determination of the verification order of the use cases is illustrated in FIG. 11A and FIG. 11B. The initial state is specified by the user in FIG. 11A to FIG. 11B. It is assumed that the use case U#6 is specified as the target use case by the user.

FIG. 11A and FIG. 11B are descriptive diagrams illustrating the other example of the determination of the verification order of the use cases. The other example of the determination of the verification order of the use cases in a state in which the use case U#1 to a use case U#8 exist is illustrated in FIG. 11A and FIG. 11B. The use case U#1 to the use case U#6 are the same as the use case U#1 to the use case U#6 from which the preconditions and the postconditions are extracted in FIG. 6. The use case U#7 and the use case U#8 have the preconditions and the postconditions illustrated in FIG. 11A.

The example of the determination of the verification order of the use case U#1 to the use case U#8 will be described with reference to FIG. 11B. First, the verification support apparatus 100 sets the initial state and all the use cases in nodes. In the example in FIG. 11B, the verification support apparatus 100 sets the initial state in a node nlni. The verification support apparatus 100 sets the use case U#1 to the use case U#8 in a node nU#1 to a node nU#8, respectively.

Then, the verification support apparatus 100 connects the node in the initial state to the node of the use case having the precondition coinciding with the initial values of the input value and the output values with an edge. In the example in FIG. 11B, the verification support apparatus 100 connects the node nlni to the node nU#1 with an edge e1. If multiple use cases having the precondition coinciding with the initial values exist, the verification support apparatus 100 connects the nodes of the multiple use cases having the precondition coinciding with the initial values of the node in the initial state to each other with edges. The verification support apparatus 100 may group the multiple use cases having the precondition coinciding with the initial values. The condition of the grouping is described above with reference to FIG. 8. The nodes of the use cases subjected to the grouping are processed as one node.

Then, the verification support apparatus 100 connects the node connected to the node in the initial state with the edge to the node of the use case having the precondition coinciding with the postcondition of the node of the use case connected with the edge with an edge. If multiple use cases having the precondition coinciding with the postcondition of the node of the use case connected with the edge exist, the verification support apparatus 100 connects the node of the use case connected with the edge to the respective nodes of the multiple use cases with edges. The verification support apparatus 100 repeats the connection of the nodes with edges until the connection reaches the target use case.

In the example in FIG. 11B, the verification support apparatus 100 connects the node nU#1 to the node nU#2 with an edge. The verification support apparatus 100 further connects the node nU#1 to the node nU#3 with an edge.

The verification support apparatus 100 may group the multiple use cases having the precondition coinciding with the postcondition of the node of the use case connected with the edge. The nodes of the use cases subjected to the grouping are processed as one node. In the example in FIG. 11B, the verification support apparatus 100 groups the use case U#2 and the use case U#3 to group the node nU#2 and the node nU#3 into one node nUg#1. The verification support apparatus 100 connects the node nU#1 to the node nUg#1 with an edge e2.

Similarly, the verification support apparatus 100 connects the node nUg#1 to a node nUg#2 resulting from grouping of the node nU#4 and the node nU#5 with an edge e3. The verification support apparatus 100 connects the node nUg#1 to the node nU#7 with an edge e4. The verification support apparatus 100 connects the node nU#7 to the node nU#8 with an edge e5. The verification support apparatus 100 connects the node nU#8 to the node nUg#2 with an edge e6. The verification support apparatus 100 connects the node nUg#2 to the node nU#6 with an edge e7.

After the respective nodes are connected with the edges, the verification support apparatus 100 sets the node nlni in the initial state to a defined state indicating that the verification order of the use cases is defined and sets the node nU#1 to the node nU#8 to an undefined state indicating that the verification order of the use cases is not defined. The order in which the respective nodes are set to the defined state represents the verification order of the corresponding use cases. The verification support apparatus 100 sequentially sets the nodes connected to the node in the defined state with the edge to the defined state.

FIG. 11B illustrates a state in which the node nUg#1 is set to the defined state. If multiple nodes are connected to the node in the defined state with the edges, the verification support apparatus 100 calculates the costs of the nodes that are connected to set the node having the minimum cost to the defined state. The cost of each node indicates the closeness to the target use case. Specifically, the cost of each node corresponds to the number of conditions that are not met by the postconditions of the connected nodes in the precondition of the target use case.

For example, an example of how to calculate the cost of the node nUg#2 and the cost of the node nU#7 will now be described. The precondition of the use case U#6, which is the target use case, includes a first condition “internal power mode==A”, a second condition “OUTPUT4==H”, and a third condition “OUTPUT5==H”. Since the second condition and the third condition are met by the postcondition of the node nUg#2, the cost of the node nUg#2 is 3−2=1. In contrast, since the second condition is met by the postcondition of the node nU#7, the cost of the node nU#7 is 3−1=2. Accordingly, the verification support apparatus 100 sets the node nUg#2 having the lower cost to the defined state.

After the node nUg#2 is set to the defined state, the verification support apparatus 100 sets the node nU#6, which is the node of the target use case, to the defined state. Since the connection reaches the target use case, the verification support apparatus 100 outputs the initial state→U#1→U#2 & U#3→U#4 & U#5→U#6 as the verification order of the use cases.

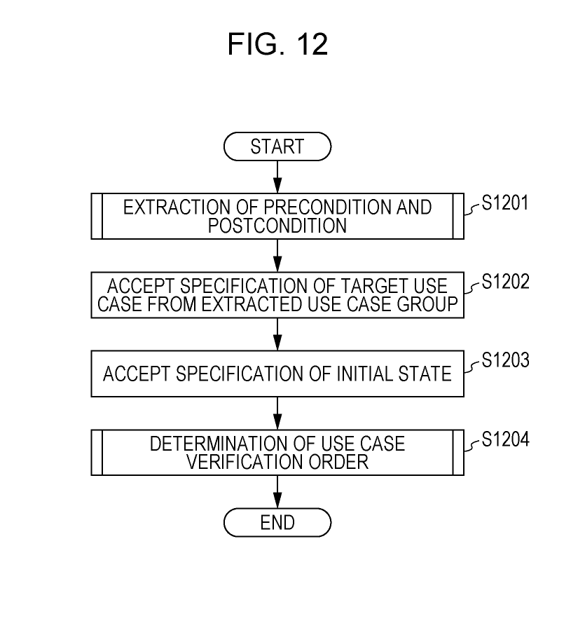

Flowcharts executed by the verification support apparatus 100 will now be described with reference to FIG. 12 to FIG. 18.

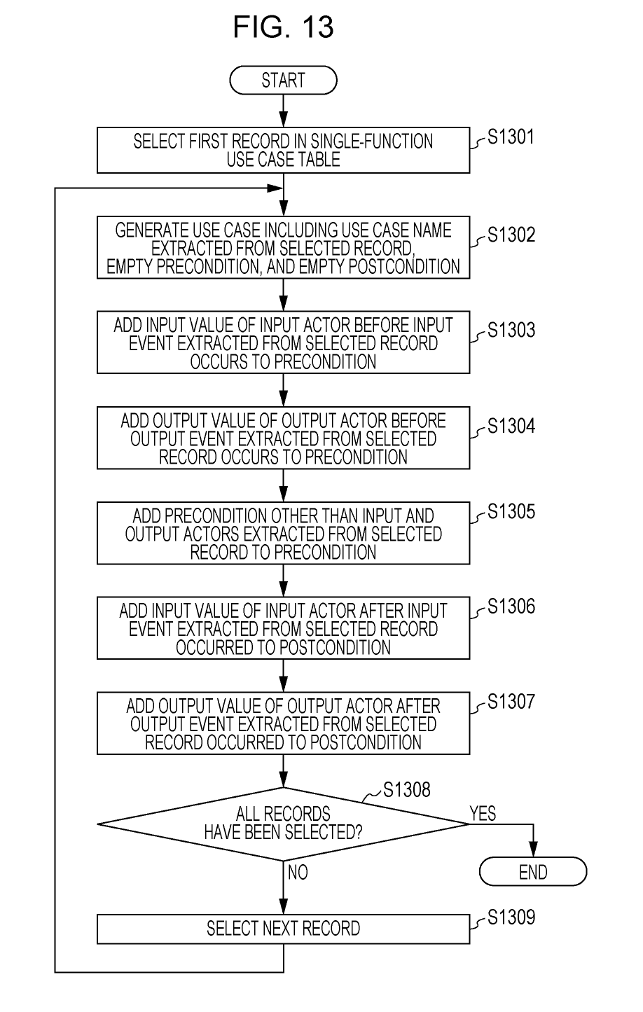

FIG. 12 is a flowchart illustrating an exemplary process of generating the test pattern. The test pattern is generated in the process of generating the test pattern. Referring to FIG. 12, in Operation S1201, the verification support apparatus 100 performs extraction of the precondition and the postcondition. The extraction of the precondition and the postcondition will be described below with reference to FIG. 13. In Operation S1202, the verification support apparatus 100 accepts specification of the target use case from the use case group that is extracted. In Operation S1203, the verification support apparatus 100 accepts specification of the initial state. In Operation S1202 and Operation S1203, the verification support apparatus 100 accepts the specification of the target use case and the specification of the initial state from the results of operations by the user of the verification support apparatus 100 with the keyboard 208 and/or the mouse 209.

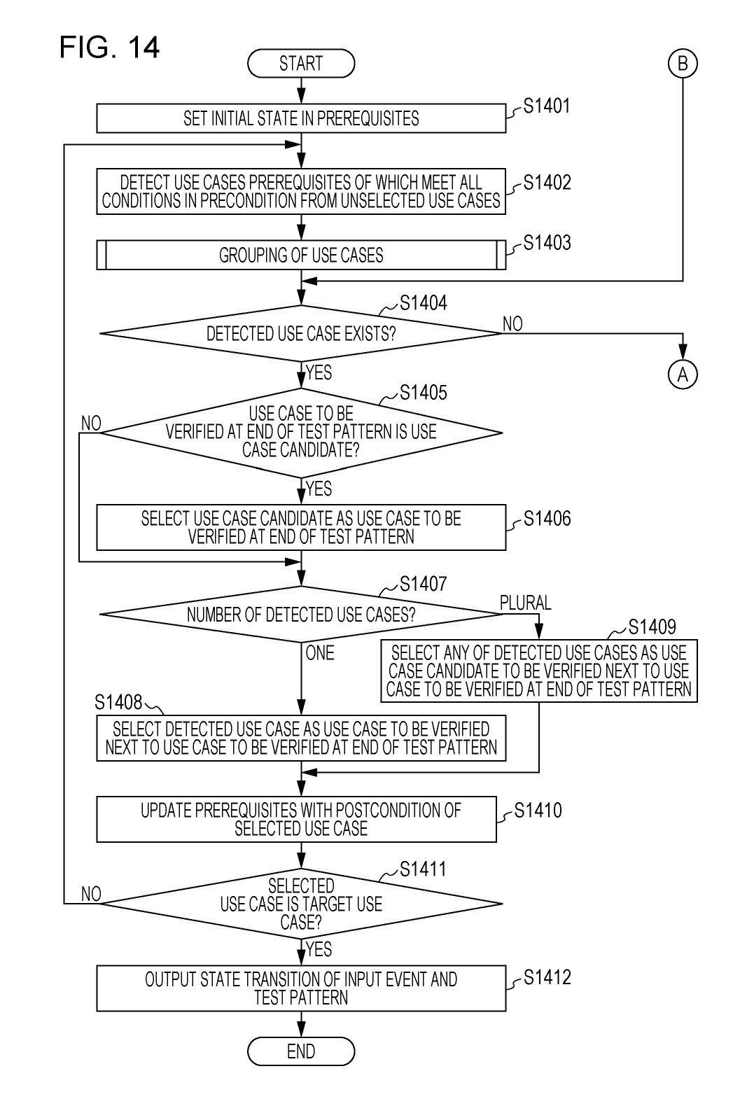

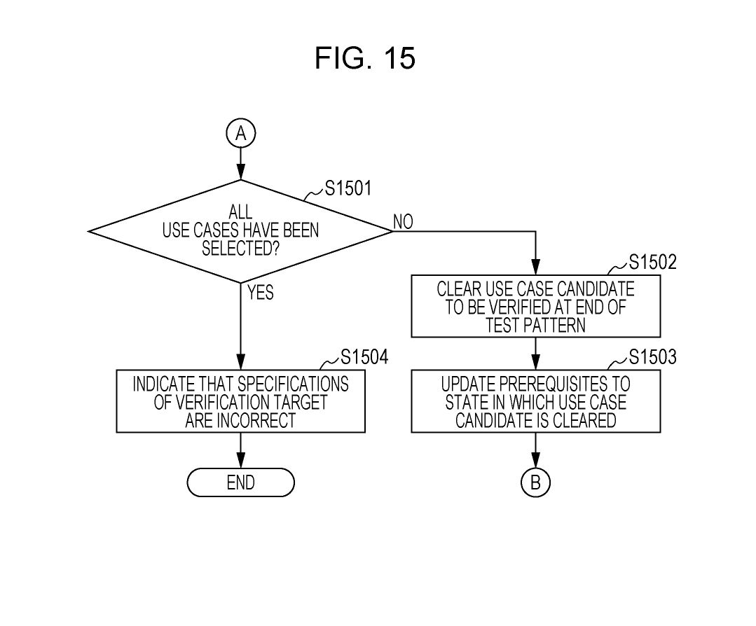

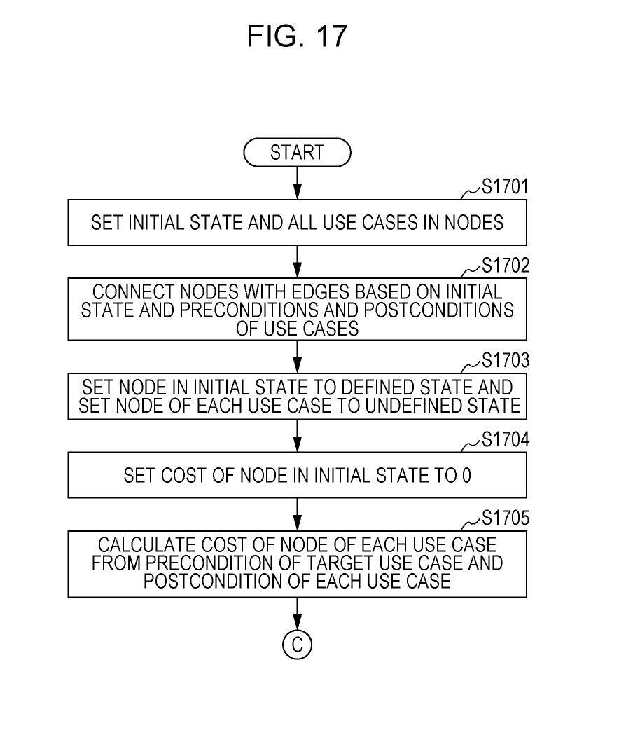

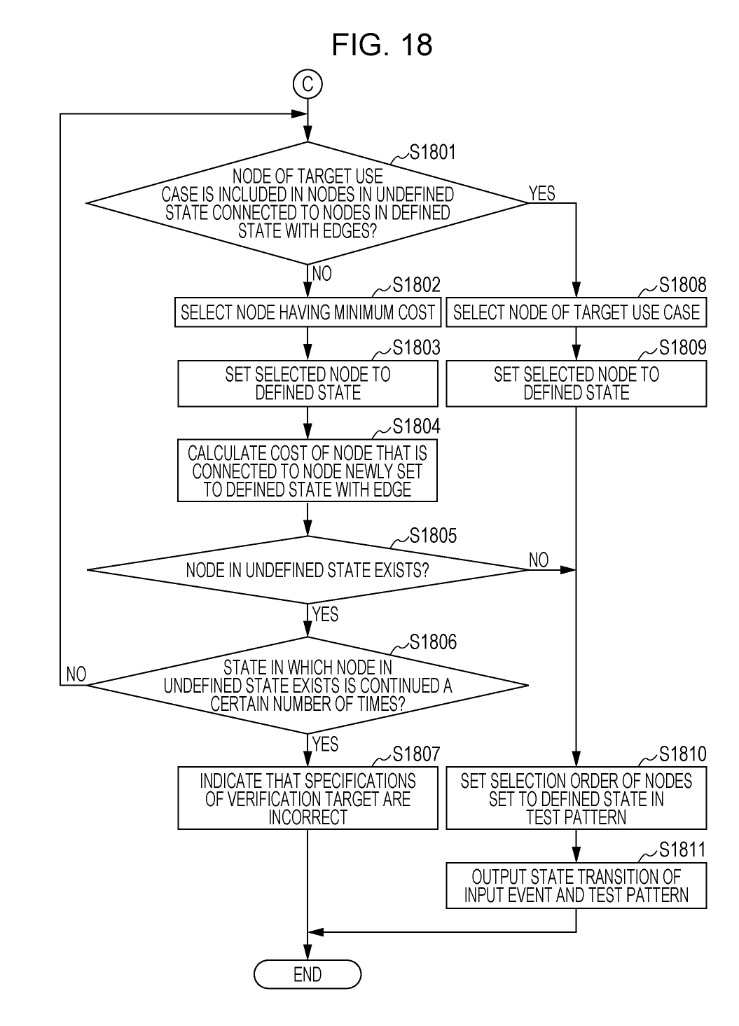

In Operation S1204, the verification support apparatus 100 performs determination of the use case verification order. An example of the determination of the use case verification order will be described below with reference to FIG. 14 and FIG. 15 and another example of the determination of the use case verification order will be described below with reference to FIG. 17 and FIG. 18. After Operation S1204, the process of generating the test pattern is terminated. The verification support apparatus 100 may perform the process of generating the test pattern to generate the test pattern indicating the verification order of the use cases.

FIG. 13 is a flowchart illustrating an example of the process of extracting the precondition and the postcondition. The precondition and the postcondition of a use case are extracted from the single-function use case table 402 in the process of extracting the precondition and the postcondition.

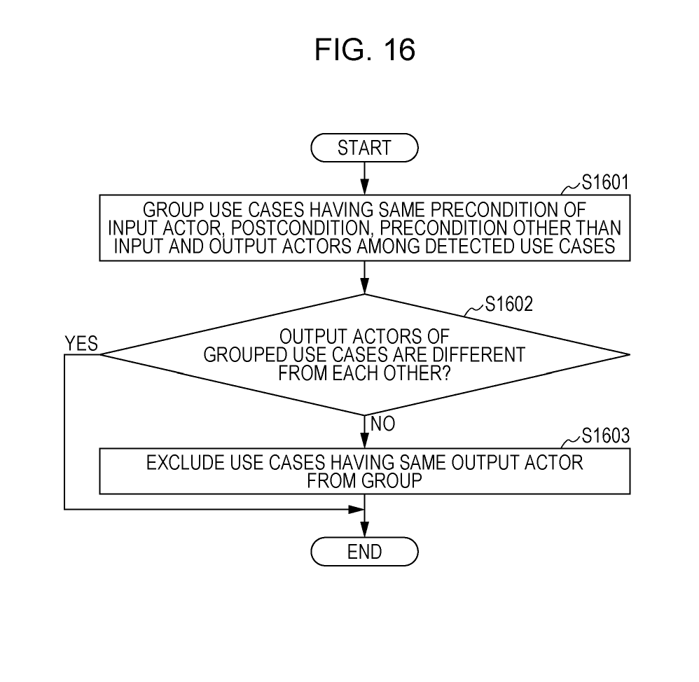

Referring to FIG. 13, in Operation S1301, the verification support apparatus 100 selects the first record in the single-function use case table 402. In Operation S1302, the verification support apparatus 100 generates a use case including the use case name extracted from the selected record, an empty precondition, and an empty postcondition. When a process of grouping the use cases illustrated in FIG. 16 is executed, the verification support apparatus 100 includes the input actor, the input event, the precondition other than the input and output actors, the output actor, and the output event of the selected record in the generated use case.

In Operation S1303, the verification support apparatus 100 adds the input value of the input actor before the input event extracted from the selected record occurs to the precondition. In operation S1304, the verification support apparatus 100 adds the output value of the output actor before the output event extracted from the selected record occurs to the precondition. In Operation S1305, the verification support apparatus 100 adds the precondition other than the input and output actors extracted from the selected record to the precondition.

In Operation S1306, the verification support apparatus 100 adds the input value of the input actor after the input event extracted from the selected record occurred to the postcondition. In Operation S1307, the verification support apparatus 100 adds the output value of the output actor after the output event extracted from the selected record occurred to the postcondition.

In Operation S1308, the verification support apparatus 100 determines whether all the records in the single-function use case table 402 have been selected. If any record that is not selected exists (No in Operation S1308), in Operation S1309, the verification support apparatus 100 selects the next record. Then, the process goes back to Operation S1302.

If all the records in the single-function use case table 402 have been selected (Yes in Operation S1308), the process of extracting the precondition and the postcondition is terminated. The verification support apparatus 100 may perform the process of extracting the precondition and the postcondition to extract the precondition and the postcondition of the use case.

FIG. 14 is a first flowchart illustrating an example of the process of determining the verification order of the use cases. FIG. 15 is a second flowchart illustrating the example of the process of determining the verification order of the use cases. The verification order of the use cases is determined in the process of determining the verification order of the use cases illustrated in FIG. 14 and FIG. 15.

Referring to FIG. 14, in Operation S1401, the verification support apparatus 100 sets the initial state in the prerequisites. In Operation S1402, the verification support apparatus 100 detects the use cases the prerequisites of which meet all the conditions in the precondition, among the use cases that are not selected. In Operation S1403, the verification support apparatus 100 performs the grouping of the use cases. The process of grouping the use cases will be described below with reference to FIG. 16.

After Operation S1403 or Operation S1503 illustrated in FIG. 15, in Operation S1404, the verification support apparatus 100 determines whether the use case that is detected exists. If the use case that is detected does not exist (NO in Operation S1404), the process goes to Operation S1501 illustrated in FIG. 15.

If the use case that is detected exists (YES in Operation S1404), in Operation S1405, the verification support apparatus 100 determines whether the use case to be verified at the end of the test pattern is the use case candidate. The use case candidate is set in Operation S1409 described below. If the use case to be verified at the end of the test pattern is the use case candidate (YES in Operation S1405), in Operation S1406, the verification support apparatus 100 selects the use case candidate as the use case to be verified at the end of the test pattern.

After Operation S1406 or if the use case to be verified at the end of the test pattern is not the use case candidate (NO in Operation S1405), in Operation S1407, the verification support apparatus 100 determines the number of the detected use cases. If the number of the detected use cases is one (ONE in Operation S1407), in Operation S1408, the verification support apparatus 100 selects the detected use case as the use case to be verified next to the use case to be verified at the end of the test pattern.

If multiple use cases are detected (PLURAL in Operation S1407), in Operation S1409, the verification support apparatus 100 selects any of the detected use cases as the use case candidate to be verified next to the use case to be verified at the end of the test pattern.

After Operation S1408 or Operation S1409, in Operation S1410, the verification support apparatus 100 updates the prerequisites with the postcondition of the selected use case. In Operation S1411, the verification support apparatus 100 determines whether the selected use case is the target use case. If the selected use case is not the target use case (NO in Operation S1411), the process goes back to Operation S1402.

If the selected use case is the target use case (YES in Operation S1411), in Operation S1412, the verification support apparatus 100 outputs the state transition of the input event and the test pattern. After Operation S1412, the process of determining the verification order of the use cases is terminated.

Referring to FIG. 15, in Operation S1501, the verification support apparatus 100 determines whether all the use cases have been selected. If the use cases that have not been selected exist (NO in Operation S1501), in Operation S1502, the verification support apparatus 100 clears the use case candidate to be verified at the end of the test pattern. In Operation S1503, the verification support apparatus 100 updates the prerequisites to the state in which the use case candidate is cleared.

Specific examples of Operation S1502 and Operation S1503 will now be described. It is assumed that the use case at the end of the test pattern is the use case U#1 and that the verification support apparatus 100 has detected the use case U#2 and the use case U#3 in Operation S1402. It is also assumed that the verification support apparatus 100 has selected the use case U#2 as the use case candidate to be verified next to the use case U#1 to be verified at the end of the test pattern in Operation S1409. The verification support apparatus 100 makes the negative determination in Operation S1411 and the process goes back to Operation S1402. If no use case is detected as the result of the processing in Operation S1402, the verification support apparatus 100 makes the negative determination in Operation S1404.

Since the use case U#2 is not selected, the verification support apparatus 100 makes the negative determination in Operation S1501 and clears the use case U#2 in Operation S1502. The verification support apparatus 100 updates the prerequisites to the state in which the use case U#2 is cleared, that is, the state in which the prerequisites are updated with the postcondition of the use case U#1 in Operation S1503.

After Operation S1503, the process goes back to Operation S1404. If all the use cases have been selected (YES in Operation S1501), in Operation S1504, the verification support apparatus 100 indicates that the specifications of the verification target 101 are incorrect because the target use case is not reached. After Operation S1504, the process of determining the verification order of the use cases is terminated. The verification support apparatus 100 may perform the process of determining the verification order of the use cases to provide the efficient verification order of the use cases.

FIG. 16 is a flowchart illustrating an example of the process of grouping the use cases. The use cases detected in Operation S1402 are subjected to the grouping in the process of grouping the use cases.

Referring to FIG. 16, in Operation S1601, the verification support apparatus 100 groups the use cases having the same precondition of the input actor, the same postcondition, and the same precondition other than the input and output actors, among the detected use cases. In Operation S1602, the verification support apparatus 100 determines whether the output actors of the use cases subjected to the grouping are different from each other. If some of the use cases subjected to the grouping have the same output actor (NO in Operation S1602), in Operation S1603, the verification support apparatus 100 excludes the use cases having the same output actor from the corresponding group.

After Operation S1603 or if the output actors of the use cases subjected to the grouping are different from each other (YES in Operation S1602), the process of grouping the use cases is terminated. The verification support apparatus 100 may perform the process of grouping the use cases to group multiple use cases.

FIG. 17 is a first flowchart illustrating another example of the process of determining the verification order of the use cases. FIG. 18 is a second flowchart illustrating the other example of the process of determining the verification order of the use cases. The verification order of the use cases is determined by using a Dijkstra method in the process of determining the verification order of the use cases illustrated in FIG. 17 and FIG. 18.

Referring to FIG. 17, in Operation S1701, the verification support apparatus 100 sets the initial state and all the use cases in the nodes. In Operation S1702, the verification support apparatus 100 connects the nodes with the edges on the basis of the initial state and the preconditions and the postconditions of the use cases. How to connect the nodes with the edges is described above with reference to FIG. 11B.

In Operation S1703, the verification support apparatus 100 sets the node in the initial state to the defined state and sets the node of each use case to the undefined state. In Operation S1704, the verification support apparatus 100 sets the cost of the node in the initial state to zero. In Operation S1705, the verification support apparatus 100 calculates the cost of the node of each use case from the precondition of the target use case and the postcondition of each use case. How to calculate the cost of the node of each use case is described above with reference to FIG. 11B.

After Operation S1705, in Operation S1801 in FIG. 18, the verification support apparatus 100 determines whether the node of the target use case is included in the nodes in the undefined state connected to the nodes in the defined state with the edges. If the node of the target use case is not included in the nodes in the undefined state connected to the nodes in the defined state with the edges (NO in Operation S1801), in Operation S1802, the verification support apparatus 100 selects the node having the minimum cost, among the nodes in the undefined state connected to the nodes in the defined state with the edges. In Operation S1803, the verification support apparatus 100 sets the selected node to the defined state. In Operation S1804, the verification support apparatus 100 calculates the cost of the node that is connected to the node newly set to the defined state with the edge from the precondition of the target use case and the postcondition of each use case.

In Operation S1805, the verification support apparatus 100 determines whether any node in the undefined state exists. If any node in the undefined state exists (YES in Operation S1805), in Operation S1806, the verification support apparatus 100 determines whether the state in which the node in the undefined state exists is continued a certain number of times. The certain number of times is a value specified by a developer or the user of the verification support apparatus 100. For example, a high value is set as the certain number of times when a large number of use cases exist and a low value is set as the certain number of times when a small number of use cases exist.

If the state in which the node in the undefined state exists is not continued a certain number of times (NO in Operation S1806), the process goes back to Operation S1801. If the state in which the node in the undefined state exists is continued a certain number of times (YES in Operation S1806), in Operation S1807, the verification support apparatus 100 indicates that the specifications of the verification target 101 are incorrect because the node of the target use case is not reached. After Operation S1807, the process of determining the verification order of the use cases is terminated.

If the node of the target use case is included in the nodes in the undefined state connected to the nodes in the defined state with the edges (YES in Operation S1801), in Operation S1808, the verification support apparatus 100 selects the node of the target use case. In Operation S1809, the verification support apparatus 100 sets the selected node to the defined state.

After Operation S1809 or if all the nodes are in the defined state (NO in Operation S1805), in Operation S1810, the verification support apparatus 100 sets the selection order of the nodes set to the defined state in the test pattern. In Operation S1811, the verification support apparatus 100 outputs the state transition of the input event and the test pattern. After Operation S1811, the process of determining the verification order of the use cases is terminated.

The verification support apparatus 100 may perform the process of determining the verification order of the use cases to generate the test pattern indicating the verification order of the use cases. Although the Dijkstra method is used in the process of determining the verification order of the use cases illustrated in FIG. 17 and FIG. 18, A* algorithm may be adopted.

The verification support apparatus 100 may perform the process of determining the verification order of the use cases illustrated in FIG. 17 and FIG. 18 to generate the test pattern in which the number of use cases to be verified is smaller than that in the process of determining the verification order of the use cases illustrated in FIG. 14 and FIG. 15.

In the process of determining the verification order of the use cases according to the embodiments, the unselected use cases may exist after the test pattern is generated. In such a case, the verification support apparatus 100 may perform the process of determining the verification order of the use cases for the unselected use cases.

The verification order from the initial state to the target use case is determined by selecting the use cases in the process of determining the verification order of the use cases according to the embodiments. In contrast, the verification support apparatus 100 may select the use cases from the target use case to the initial state to use the verification order opposite to the selection order.

As described above, the verification support apparatus 100 performs the matching in the precondition and the postcondition between the use cases representing the functions of the verification target to select the use case that is continuously executed. Accordingly, since the verification support apparatus 100 varies the state of the verification target in accordance with the use case to be verified next, the time and effort for the verification is reduced to increase the efficiency of the verification.

The verification support apparatus 100 may select the second use case having the precondition coinciding with the postcondition of the first use case from the use case group. Since, after the verification support apparatus 100 verifies the function of a use case, the verification support apparatus 100 verifies the function of the next use case without varying the input value and the output value, the verifier is capable of efficiently performing the verification.

If multiple use cases having the precondition coinciding with the postcondition of the first use case exist, the verification support apparatus 100 may select the use case candidate to be verified next to the first use case from the multiple use cases. If the verification support apparatus 100 determines that any use case having the precondition coinciding with the postcondition of the use case candidate exists, the verification support apparatus 100 may select the use case candidate as the second use case. Accordingly, the verification support apparatus 100 may generate the test pattern with which a large number of use cases are capable of being verified.

If multiple use cases having the precondition coinciding with the postcondition of the first use case exist, the verification support apparatus 100 may select the use case candidate to be verified next to the first use case from the multiple use cases. If the verification support apparatus 100 determines that no use case having the precondition coinciding with the postcondition of the use case candidate exists, the verification support apparatus 100 may select the unselected use case that is not selected from the multiple use cases as the use case candidate. The possibility of generating the test pattern with which a larger number of use cases are capable of being verified is increased, compared with the case in which the verification support apparatus 100 does not determine that no use case having the precondition coinciding with the postcondition of the use case candidate exists.

If the verification support apparatus 100 determines that no use case having the precondition coinciding with the postcondition of the first use case exists, the verification support apparatus 100 may output the test pattern, which is information indicating the selection order of the use cases selected from the use case group. The verifier is capable of performing the verification in accordance with the output test pattern to efficiently perform the verification.

If no use case having the precondition coinciding with the postcondition of the first use case exists and the target use case is not included in the selected use cases, the verification support apparatus 100 may output the information indicating that the specifications of the verification target 101 are incorrect. In this case, since the state in which the target use case is executed does not arise, the verifier knows that the specifications of the verification target 101 are incorrect.

If multiple use cases having the precondition coinciding with the postcondition of the first use case exist and a specific use case is included in the multiple use cases, the verification support apparatus 100 may select the specific use case as the second use case. Accordingly, the verification support apparatus 100 may generate the test pattern in which a small number of use cases are verified until the target use case is reached. The test pattern in which a small number of use cases are verified is used in, for example, a case in which the verification time is short and the minimum verification is desired. If multiple verification targets 101 exist, multiple test patterns in which a small number of use cases are verified may be prepared and the test patterns for the respective verification targets 101 may be verified in parallel to reduce the verification time.

It is assumed that multiple use cases having the precondition coinciding with the postcondition of the first use case exist and a specific use case is not included in the multiple use cases. In this case, the verification support apparatus 100 may select the second use case from the multiple use cases on the basis of the postcondition of each of the multiple use cases and the precondition of the specific use case. Accordingly, the verification support apparatus 100 may generate the test pattern in which a small number of use cases are verified until the target use case is reached.

The verification support apparatus 100 may select the use case to be verified first from the use case group on the basis of the initial values of the input value and the output value and the precondition of each use case in the use case group. In this case, since the verifier does not specify the use case to be verified first, the verification support apparatus 100 is capable of efficiently performing the verification.

Since the verification support apparatus 100 is capable of automatically generate the test pattern from the specifications, the number of operations in the verification may be reduced. The automatic generation of the test pattern from the specifications in the verification support apparatus 100 suppresses an occurrence of omission of the verification items or verification errors. The verification support apparatus 100 is capable of improving the coverage of the test by generating the test pattern and repeating the generation of the test pattern for the unselected use cases to finally select all the use cases.

The verification support method described above in the embodiments may be realized by a computer, such as a personal computer or a workstation, which executes a program prepared in advance. The verification support program is recorded on a computer-readable recording medium, such as a hard disk, a flexible disk, a compact disk-read only memory (CD-ROM), a magneto-optical (MO) disk, or a digital versatile disk (DVD), and is read out from the recording medium by the computer for execution. The verification support program may be distributed via a network, such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A verification support method, comprising:
referring to a storage to select a second use case to be verified next to a first use case selected from a use case group from the use case group on the basis of a postcondition of the first use case and a precondition of a use case different from the first use case, the storage storing, for use case representing a function of a verification target, the precondition that is met by an input value to be input into the verification target and an output value to be output from the verification target before the function represented by the use case is executed and the postcondition that is met by the input value and the output value after the function represented by the use case is executed.

2. A non-transitory computer-readable recording medium having stored therein a program for causing a computer to execute a verification support process comprising:
referring to a storage to select a second use case to be verified next to a first use case selected from a use case group from the use case group on the basis of a postcondition of the first use case and a precondition of a use case different from the first use case, the storage storing, for use case representing a function of a verification target, the precondition that is met by an input value to be input into the verification target and an output value to be output from the verification target before the function represented by the use case is executed and the postcondition that is met by the input value and the output value after the function represented by the use case is executed.

3. The non-transitory computer-readable recording medium according to claim 2,
wherein the selecting the second use case selects the second use case having the precondition coinciding with the postcondition of the first use case from the use case group.

4. The non-transitory computer-readable recording medium according to claim 3 storing the computer program causing the computer to further execute:
determining whether the use case having the precondition coinciding with the postcondition of the first use case exists in unselected use cases that are not selected from the use case group;
selecting, when it is determined that a plurality of use cases having the precondition coinciding with the postcondition of the first use case exists, a use case candidate to be verified next to the first use case from the plurality of use cases; and
determining whether the use case having the precondition coinciding with the postcondition of the use case candidate exists in the unselected use cases that are not selected from the use case group,
wherein the selecting the second use case selects the use case candidate as the second use case when it is determined that the use case having the precondition coinciding with the postcondition of the use case candidate exists.

5. The non-transitory computer-readable recording medium according to claim 4 storing the computer program causing the computer to further execute:
selecting the unselected use case that is not selected from the plurality of use cases as the use case candidate when it is determined that no use case having the precondition coinciding with the postcondition of the use case candidate exists.

6. The non-transitory computer-readable recording medium according to claim 4 storing the computer program causing the computer to further execute:
outputting information indicating a selection order of the use cases selected from the use case group when it is determined that no use case having the precondition coinciding with the postcondition of the first use case exists.

7. The non-transitory computer-readable recording medium according to claim 4 storing the computer program causing the computer to further execute:
determining whether a specific use case is included in the use cases selected from the use case group when it is determined that no use case having the precondition coinciding with the postcondition of the first use case exists; and
outputting information indicating that specifications of the verification target are incorrect when it is determined that the specific use case is not included in the use cases selected from the use case group.

8. The non-transitory computer-readable recording medium according to claim 4 storing the computer program causing the computer to further execute:
determining, when it is determined that a plurality of use case having the precondition coinciding with the postcondition of the first use case exists, whether a specific use case is included in the plurality of use cases,
wherein the selecting the second use case selects the specific use case as the second use case when it is determined that the specific use case is included in the plurality of use cases.

9. The non-transitory computer-readable recording medium according to claim 8,
wherein the selecting the second use case selects the second use case from the plurality of use cases on the basis of the postcondition of each of the plurality of use cases and the precondition of the specific use case when it is determined that the specific use case is not included in the plurality of use cases.

10. The non-transitory computer-readable recording medium according to claim 2 storing the computer program causing the computer to further execute:
selecting a use case to be verified first from the use case group on the basis of initial values of the input value and the output value and the precondition of each use case in the use case group.

11. A verification support apparatus, comprising:
a storage configured to store, for use case representing a function of a verification target, a precondition that is met by an input value to be input into the verification target and an output value to be output from the verification target before the function represented by the use case is executed and a postcondition that is met by the input value and the output value after the function represented by the use case is executed; and
a computer configured to refer to the storage to select a second use case to be verified next to a first use case selected from a use case group from the use case group on the basis of the postcondition of the first use case and the precondition of a use case different from the first use case.
